(19) United States
(12) Patent Application Publication
(10) Pub. No.: US 2005/0063278 A1
(43) Pub. Date: Mar. 24, 2005

(54) Method of directly reproducing main title and disc player using the same

(76) Inventor: Suk-hoon Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/912,536

(22) Filed: Aug. 6, 2004

(30) Foreign Application Priority Data
Aug. 8, 2003 (KR) 2003-55028

(51) Int. Cl. H04N 5/76; G11B 31/00; H04N 5/91

(52) U.S. Cl. 369/70; 386/69

(57) ABSTRACT

Provided are a method of directly detecting and reproducing a main title stored in a disc in a read mode, a disc player using the same, and a computer readable medium of instructions for performing the same. The method includes determining whether a direct reproduction mode is enabled, detecting title information stored in a predetermined area of a disc when the direct reproduction mode is enabled, detecting a main title having the longest reproduction time from the detected title information detected, and reproducing the detected main title.

This application claims the benefit under 35 U.S.C. §119(a) of Korean Patent Application No. 2003-55028, filed on Aug. 8, 2003, in the Korean Intellectual Property Office, the entire disclosure of which is hereby incorporated by reference.

### BACKGROUND OF THE INVENTION

1. Field of the Invention

The present invention relates to a method and apparatus for controlling a disc player. More particularly, the present invention relates to a method of directly detecting and reproducing a main title stored on a disc in a read mode, and a disc player using the same.

2. Description of the Related Art

In general, a disc player adopts an on-screen display (OSD) that is an interactive user interface to increase user convenience when reproducing data stored on a digital versatile disc or a digital video disc (DVD). Two menus are available with respect to a DVD. One of the menus is a system menu that includes a volume manager menu that can be set regardless of a type of disc and a video title set menu that can be set regardless a type of title set. The system menu can be invoked by pressing a predetermined button installed on a disc player when information stored on a disc is being reproduced. The other menu is a selection menu enabling the selection of a title or chapter stored on the disc, the selection menu being made arbitrarily by a title manufacturer. In particular, the selection menu is set to be automatically invoked after reproducing initial titles (or chapters) such as logos when driving a disc.

Accordingly, when reproduction of information stored on a disc begins, a user must unavoidably view initial titles, such as various logos, which are arbitrarily recorded by a disc manufacturer, before the selection menu is reproduced and displayed on a screen. The user manipulates keys based on the selection menu to select a desired title, presses a key to select a reproduction mode, and then, view the desired title.

For this reason, a conventional disc player is inconvenient since the user has to manipulate keys thereof several times in order to view a desired title stored on a disc. Further, when driving the disc, the user must unavoidably view various publicity logo screens manufactured by a disc manufacturer.

### SUMMARY OF THE INVENTION

The present invention provides a method of controlling direct reproduction of a main title, in which a main title is directly searched for on a disc and reproduced, and a disc player using the same.

According to an aspect of the present invention, there is provided a method of controlling a disc player, the method comprising determining whether a direct reproduction mode is enabled, detecting title information stored in a predetermined area of a disc when the direct reproduction mode is enabled, detecting a main title having the longest reproduction time from the title information detected, and reproducing the main title.

According to another aspect of the present invention, there is provided a disc player comprising a pickup that includes a laser diode, a photo diode, and various lenses, and records a signal on a disc, detects an optical signal reflected from the disc, and converts the optical signal into an electrical signal; a signal processing circuit that receives the electrical signal output from the pickup, restores the electrical signal to the original audio/video (AV) data, and converts the AV data into a signal so that the AV data can be output to a speaker or a display; a servo control circuit that controls a position of the pickup and a rotating speed of the disc; a key input unit that has a plurality of function keys and a key for setting a direct reproduction mode, and transmits key information to the system controller; and a system controller that detects title information stored in a predetermined point on the disc, detects a main title having the longest reproduction time based on the detected title information, and generates a control signal for reproducing the main title when the key information selected by the key input unit specifies that an operation mode is a direct reproduction mode.

### BRIEF DESCRIPTION OF THE DRAWINGS

The above and other aspects and advantages of the present invention will become more apparent by describing in detail preferred embodiments thereof with reference to the attached drawings in which:

FIG. 1 is a block diagram of a disc player using a method of controlling direct reproduction of a main title, according to an embodiment of the present invention; and

FIG. 2 is a flowchart illustrating a method of controlling direct reproduction of a main title, according to an embodiment of the present invention.

### DETAILED DESCRIPTION OF THE INVENTION

Hereinafter, embodiments of the present invention will be described in detail with reference to the accompanying drawings.

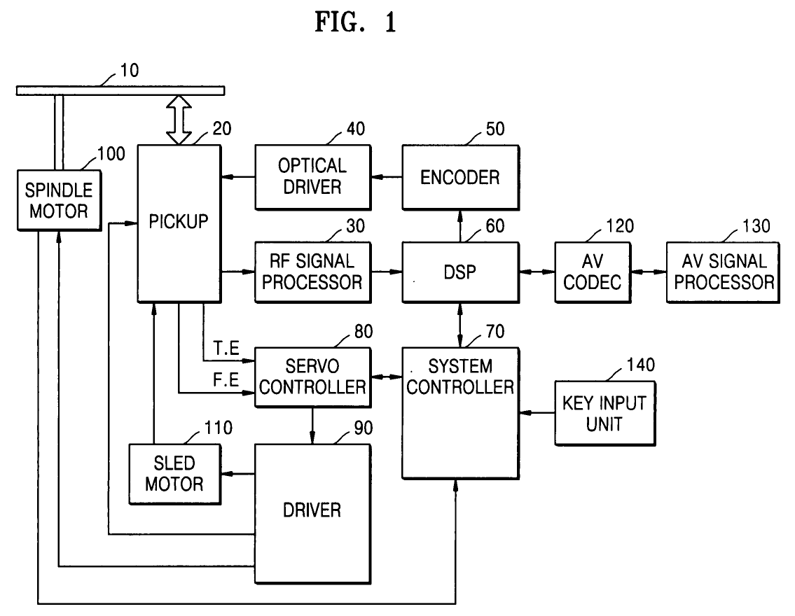

As shown in FIG. 1, a disc player according to an embodiment of the present invention includes a disc 10, a pickup 20, a radio frequency (RF) signal processor 30, an optical driver 40, an encoder 50, a digital signal processor (DSP) 60, a system controller 70, a servo controller 80, a driver 90, a spindle motor 100, a sled motor 110, an audio/video coder/decoder (AV CODEC) 120, an AV signal processor 130, and a key input unit 140.

In this following description, a circuit including the RF signal processor 30, the optical driver 40, the encoder 50, the DSP 60, the AV codec 120, and the AV signal processor 130 is referred to as a signal processing circuit. A circuit including the servo controller 80 and the driver 90 is referred to as a servo control circuit.

The operation of each element will now be described. Although not shown in the drawings, the pickup 20 includes a laser diode, a plurality of photo diodes, various lenses, and an actuator moving the lenses in a vertical or horizontal direction. The pickup 20 projects an optical signal onto the disc 10, receives the optical signal reflected from the disc 10, and converts the reflected optical signal into an electrical signal. In the pickup 20, the plurality of photo diodes are combined to generate a tracking error signal TE and a focusing error signal FE for servo control and also generate a signal for signal processing.

The RF signal processor 30 filters and equalizes the signal, for signal processing, which is output from the pickup 20. The RF signal processor 30 also converts the result into a binary signal and outputs the binary signal to the DSP 60.

The optical driver 40 outputs an optical driving signal corresponding to an input signal in a write mode and outputs a driving signal for generating laser power at a predetermined level in a read mode.

The encoder 50 converts data, which has been converted into a read format by the DSP 60, into a bitstream and outputs the bitstream to the optical driver 40.

In the read mode, the DSP 60 processes the binary signal input from the RF signal processor 30 to restore it to the original signal, using an inside phase locked clock. In the write mode, the DSP 60 adds an error correcting code (ECC) to input digital data so that the input digital data can be converted into a write format.

In the read mode, the AV codec 120 decodes the AV data input from the DSP 60 so as to extend the AV data that is compressed and encoded. In the write mode, the AV codec 120 encodes the AV data input from the AV signal processor 130 to compress the AV data.

In the read mode, the AV signal processor 130 converts the AV data, which is decoded by the AV codec 120, into an analog signal and processes the analog signal so that it can be output to a speaker (not shown) or a display (not shown).

The servo controller 80 generates a driving voltage for driving the actuator of the pickup 20 to move an optical lens of the pickup 20 in a vertical or horizontal direction, using the tracking error signal TE and the focus error signal FE. In a seek mode, the servo controller 80 generates a driving voltage for driving the sled motor 110 to move the pickup 20 to a desired track, in response to a control signal generated by the system controller 70. Also, the servo controller 80 generates a driving voltage for driving the spindle motor 100, the driving voltage corresponding to a desired spindle motor rotating speed determined by the system controller 70.

When the driving voltage generated by the servo controller 80 is applied to the driver 90, the driver 90 generates a driving current for driving the spindle motor 100 and the sled motor 110, and generates a driving current for driving the pickup 20 so as to control focusing or tracking of the optical lens of the pickup 20.

The key input unit 140 includes a variety of function keys for operating the disc player. The key input unit 140 may be installed on a body of the disc player so that function key information can be input to the system controller 70 via a wire connection. If necessary, the key input unit 140 may be a remote controller that controls the disc player via a wireless connection. According to an embodiment of the present invention, a direct reproduction function key is further installed on the key input unit 140 so that the direct reproduction function key is pressed to enable a direct reproduction mode. According to another embodiment of the present invention, the direction reproduction mode is selected in a menu screen using a menu key of the key input unit 140.

The system controller 70 controls overall operations of the disc player. In particular, when an operation mode corresponding to key information selected by the key input unit 140 is the direct reproduction mode, the system controller 70 searches for title information stored in a lead-in zone of the disc 10, detects a main title of the longest reproduction time from the searched title information, and controls the servo controller 70 to reproduce the detected main title.

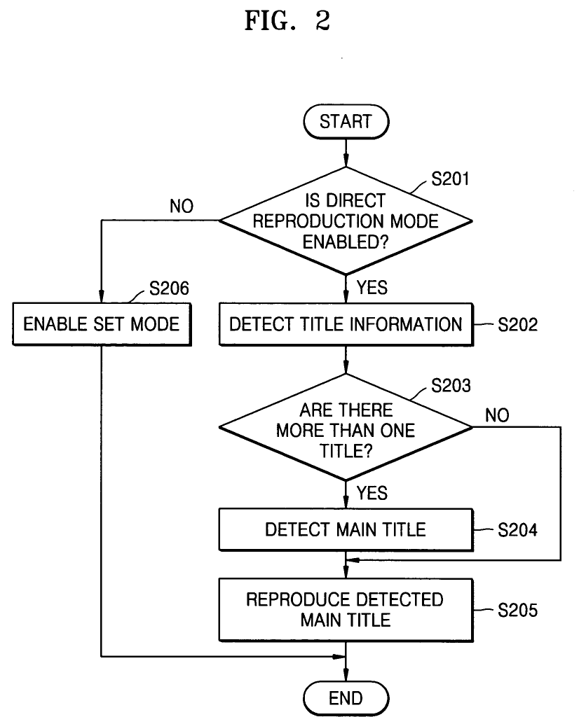

Hereinafter, a method of controlling direct reproduction of a main title, according to an embodiment of the present invention, will be described with reference to the block diagram of the disc player shown in FIG. 1 and a flowchart of FIG. 2.

First, the system controller 70 determines whether an operation mode is changed to a direct reproduction mode in step S201. The direct reproduction mode can be selected using the direct reproduction function key installed on the key input unit 140 or selected in a menu screen using a menu key.

If it is determined in step 201 that the operation mode is changed to the direct reproduction mode, the system controller 70 detects title information recorded on the disc 10 in step S202. More specifically, when the direct reproduction mode is enabled, the system controller 70 sends the servo controller 80 a command of moving the pickup 20 to the lead-in zone of the disc 10. In response to the command, in order to move the pickup 20 to the lead-in zone, the servo controller 80 generates a driving voltage for driving the sled motor 110 and outputs the driving voltage to the driver 90. Next, the driver 90 converts the driving voltage into a driving current for driving the sled motor 110 and applies the driving current to the sled motor 110, thus moving the pickup 20 to the lead-in zone. Next, the title information is detected in the lead-in zone of the disc 10 by the pickup 20, reproduced by the RF signal processor 30 and the DSP 60, and decoded by the system controller 70.

After step 202, the system controller 70 decodes the title information recorded on the disc 10 and determines whether there is more than one title in step S203.

If more than one title is recorded on the disc 10, the system controller 70 analyzes the detected title information, selects a title having the longest reproduction time from the titles, and determines the selected title as a main title in step S204.

Next, the system controller 70 controls the elements of the disc player to reproduce the determined main title in step S205.

More specifically, the system controller 70 reads, from the determined title information, location information regarding a point on the disc 10 where the main title is recorded, and transmits the read location information of the main title and a seek command to the servo controller 80. Next, the servo controller 80 generates a driving voltage for driving the sled motor 110 so that the pickup 20 can be moved to a track of the disc 10 corresponding to the point on the disc 10 specified in the location information of the main title transmitted from the system controller 70. After moving the pickup 20 to the track of the disc 10 where the main title is stored, the main title is reproduced.

When it is determined in step S203 that only one title is stored on the disc 10, the title is determined to be a main title and step S205 is performed.

If the direct reproduction mode is not enabled, the system controller 70 controls a current operation mode to be performed in step S206.

Accordingly, when a user selects the direct reproduction mode in the disc player, the main title is immediately reproduced. In this case, it is possible to prevent a user from viewing initial titles, such as logos, which are arbitrarily recorded on a disc by a disc manufacturer.

As described above, according to the present invention, a disc player can be controlled to directly search for and reproduce a main title stored on a disc in a direct reproduction mode, thus enabling the main title to be rapidly reproduced without reproducing initial titles, such as logos, which are arbitrarily recorded by a disc manufacturer.

The present invention can be realized as a method, an apparatus, a system, and so on. When the present invention is realized as software, constitutional elements of the present invention are code segments that execute necessary operations. Programs or code segments may be stored in a processor readable medium or may be transmitted by a transmission medium or by a computer data signal combined with a carrier in a communication network. The processor readable medium may be any medium, such as an electronic circuit, a semiconductor memory device, a ROM, a flash memory, an erasable ROM, a floppy disc, an optical disc, a hard disc, an optical fiber medium, or a radio frequency (RF) network, which can store or transmit information. The computer data signal may be any signal which can be transmitted through a transmission medium such as an electronic network channel, an optical fiber, air, an electromagnetic field, or an RF network.

While this invention has been particularly shown and described with reference to preferred embodiments thereof, it will be understood by those skilled in the art that various changes in form and details may be made therein without departing from the spirit and scope of the invention as defined by the appended claims.

1. A method of controlling a disc player, comprising:
determining whether a direct reproduction mode is enabled;
detecting title information stored in a predetermined area of a disc when the direct reproduction mode is enabled;
detecting a main title having the longest reproduction time from the title information; and
reproducing the main title.

2. The method of claim 1, wherein a command of enabling the direct reproduction mode is input using a direct reproduction function key installed on a key input unit.

3. The method of claim 1, wherein a command of enabling the direct reproduction mode is input in a menu screen using a key input unit.

4. The method of claim 1, wherein when the detected title information specifies only one title, the title is recognized as a main title.

5. A disc player comprising:
a pickup that includes a laser diode, a photo diode, and various lenses, and records a signal on a disc, detects an optical signal reflected from the disc, and converts the optical signal into an electrical signal;
a signal processing circuit that receives the electrical signal output from the pickup, restores the electrical signal to the original audio/video (AV) data, and converts the AV data into a signal so that the AV data can be output to a speaker or a display;
a servo control circuit that controls a position of the pickup and a rotating speed of the disc;
a key input unit that has a plurality of function keys and a key for setting a direct reproduction mode, and transmits key information to the system controller; and
a system controller that detects title information stored in a predetermined point on the disc, detects a main title having the longest reproduction time based on the detected title information, and generates a control signal for reproducing the main title when the key information selected by the key input unit specifies that an operation mode is a direct reproduction mode.

6. The disc player of claim 5, wherein a command of enabling the direct reproduction mode is input using a direct reproduction function key installed on the key input unit.

7. The disc player of claim 5, wherein a command of enabling the direct reproduction mode is input in a menu screen using the key input unit.

8. The disc player of claim 5, wherein when the title information detected from the disc specifies only one title, the system controller recognizes the title as the main title.

9. A computer readable medium of instructions for controlling a disc player comprising:
a first set of instructions adapted to control the disc player to determine whether a direct reproduction mode is enabled;
a second set of instructions adapted to control the disc player to detect title information stored on a predetermined area of a disc when the direct reproduction mode is enabled;
a third set of instructions adapted to control the disc player to detect a main title having the longest reproduction time from the title information; and
a fourth set of instructions adapted to reproduce the main title.

10. The computer readable medium of instructions of claim 9, wherein the first set of instructions receives a command of enabling the direct reproduction mode from an input using a direct reproduction key installed on a key input unit of the disc player.

11. The computer readable medium of instructions of claim 9, wherein the first set of instructions receives a command of enabling the direct reproduction mode from an input using a menu screen in combination with a key input unit of the disc player.

12. The computer readable medium of instructions of claim 9, wherein the third set of instructions is adapted to control the disc player to detect a title on the disc as a main title when the title information specifies only one title.
